(19) United States
(12) Patent Application Publication
(10) Pub. No.: US 2020/0198107 A1
(43) Pub. Date: Jun. 25, 2020

(54) Torque Tool

(71) Applicant: Lawrence Henry Schumacher, Menifee, CA (US)

(72) Inventor: Lawrence Henry Schumacher, Menifee, CA (US)

(21) Appl. No.: 16/228,382

(22) Filed: Dec. 20, 2018

(51) Int. Cl. B25B 27/30

(52) U.S. Cl. CPC B25B 27/30; E05D 13/1261

(57) ABSTRACT

My invention is a unique tool that permits the winding and unwinding (tensioning and de-tensioning) of torsion springs in situations where adjacent obstructions would otherwise disallow the normal means of this process when using normal trade tools. Sometimes access can be so limited that even the installation of similar tools can be impossible which is why I design it with removable jaw clamp bolts and assembly bolt finger clearance.

### CROSS TO RELATED CASES

Donkey Cone marketed as “patent pending” by Jeff Gabelsberg at http://donkeycone.com/.

Double Headed Spring Winding Cone, patent applied for Sep. 18, 2018 by Lawrence Henry Schumacher.

### BACKGROUND OF THE INVENTION

This invention relates to torsion springs of the type used to counter balance segmented garage doors of various types; specifically, tools used to wind and unwind them. There are several torsion spring winding (or tensioning) tools that have been invented that operate mechanically such as the “Trujillo” device (U.S. Pat. No. 8,936,063 B1, Jan. 20, 2015) and the “Primrose” device (U.S. Pat. No. 7,073,411 B2) that were invented specifically to facilitate the winding of torsion springs under normal conditions without the use of conventional hand-held winding rods, which continue to be the industry's standard means of winding torsion springs today. These devices are mechanically complex, expensive, and bulky to use and were not designed to address the problems of low clearance or minimal access to torsion springs.

In certain cases where ceilings above torsion springs are lower than normal, or when home owners or builders install shelving or other permanent obstructions directly above and/or adjacent to torsion springs, the space normally required to wind and unwind torsion springs using conventional winding rods is impeded, making it impossible to wind and unwind them. The Torque Tool was invented to address this low clearance, or minimal access, issue when using conventional winding rods.

Further objects and advantages of my invention will become apparent through consideration of the drawings and ensuing description.

### BRIEF SUMMARY OF THE INVENTION

The winding and unwinding of torsion springs is not necessarily an arduous task under normal conditions, provided that adequate overhead room is available to move the winding rods the required 90 degrees of motion, and does not require special equipment to do so. Historically this has been accomplished through the use of steel winding rods of adequate length by rotating the spring one quarter turn, or 90 degrees, at a time until the spring is wound or unwound. In some cases clearance above, under, or behind springs is limited and a full 90 degrees of turn cannot be achieved. In cases likes these the installer must use dangerously shortened or modified winding rods or manually lift the door and pre-load the springs.

The normal process of winding or unwinding torsion springs without the Torsion Tool is accomplished by placing the end of one of the two winding rods into one of four holes, spaced 90 degrees apart, in the end of the torsion spring. The winding rod is then moved upward toward the ceiling, in the case of winding, or lowered, in the case of unwinding. While holding this tension, the second winding rod is then inserted into the next exposed hole on the end of the torsion spring and it is then lifted toward the ceiling, thus transferring the winding force to the second rod. Once this load is transferred to the second winding rod the first rod can be removed from the torsion spring. This process is then repeated a certain number of times as required to fully wind the torsion spring. In situations where a full 90 degrees of motion of the winding rods cannot be accomplished, access to the second available winding hole is not possible. The Torque Tool, by adding four more winding holes, each spaced 45 degrees from one another, permits for a shorter distance of winding rod motion and allows for full access to the next winding hole.

### BRIEF DESCRIPTION OF THE SEVERAL VIEWS OF THE DRAWING

FIG. 1: Side view of clamp jaws. This view shows the assembled Torque Tool with jaws (21) oriented to the left, jaw pin or hex head machine bolt (20) in place, and bolted together by the assembly bolt (23) that is located in the assembly hole area.

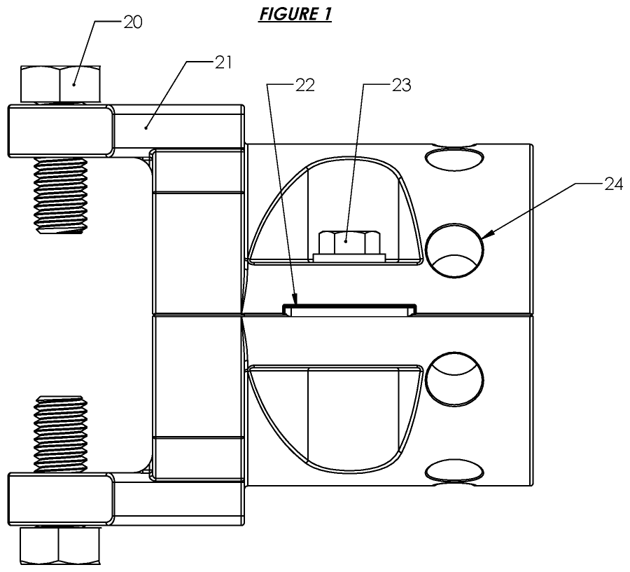

FIG. 2: Exploded three dimension view of clamp halves. This view shows the Torque Tool as it would be in preparation for assembly onto a torsion spring.

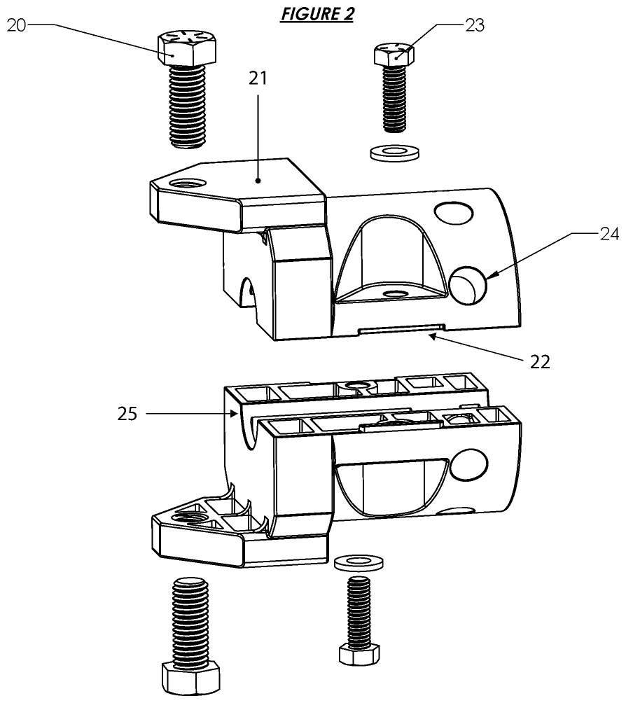

FIG. 3: Top view of clamp half. This view shows the top half of the assembled Torque Tool oriented toward the left where it would engage the winding cone of a torsion spring via the jaw pin or hex head machine bolt (20). Both Clamp Halves are secured together at the assembly hole area via the Clamp Half Fastening Bolts and Washers (23), each of which is on opposite sides the Clamp Halves.

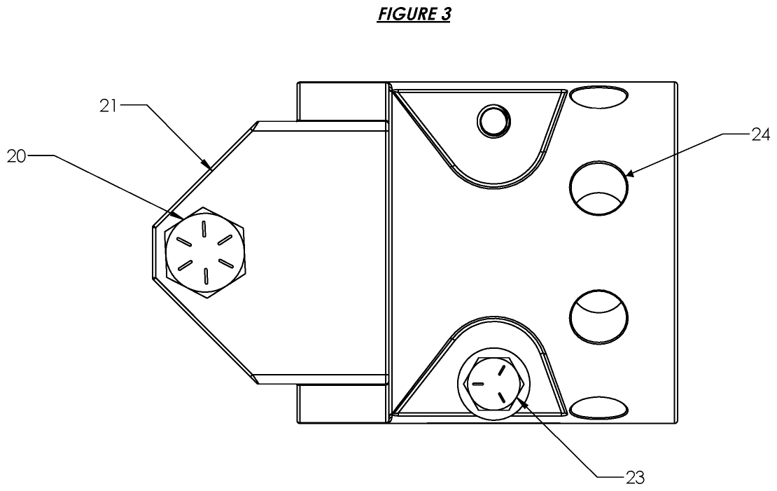

FIG. 4: Front end view of bolted clamp halves. This view shows the assembled Torque Tool from the jaw end where it engages the torsion spring with the jaw pin or hex head machine bolts (20) inserted.

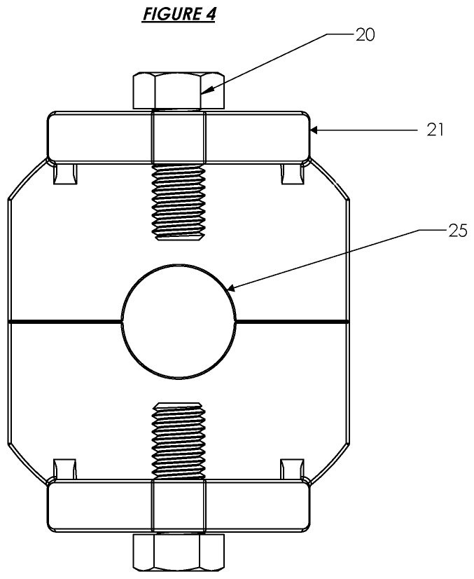

FIG. 5: Right end view of bolted clamp halves. This view shows the assembled Torque Tool from the non-working end.

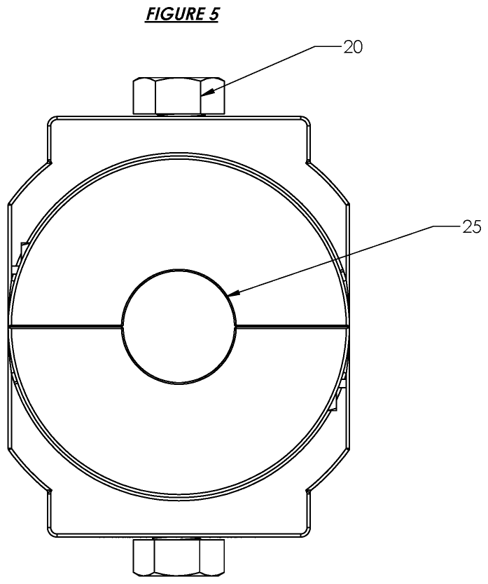

FIG. 6: Bottom view of bolted clamp halves. This view shows the bottom half of the assembled Torque Tool oriented toward the left where it would engage the winding cone of a torsion spring via the jaw pin or hex head machine bolt (20). Both Clamp Halves are secured together at the assembly hole area via the Clamp Half Fastening Bolts and Washers (23), each of which is on opposite sides the Clamp Halves. This view shows that the bottom and top halves of the Torque Tool are exact duplicates of one another.

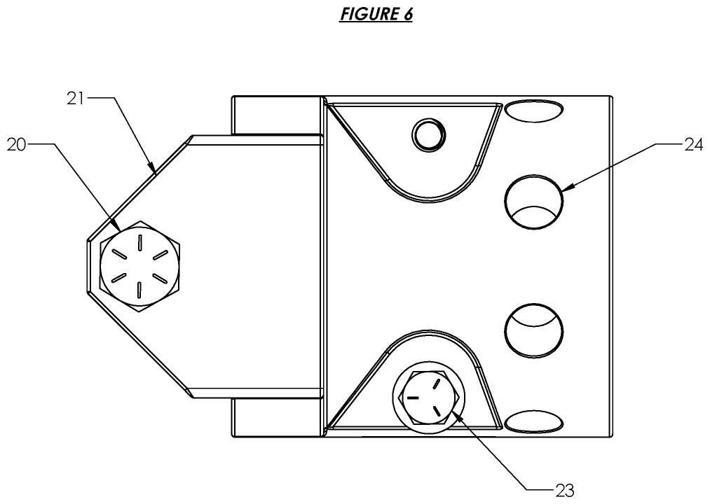

FIG. 7: Three dimensional view of bolted clamp halves. This view shows the Torque Tool as it appears assembled but not attached to a torsion spring.

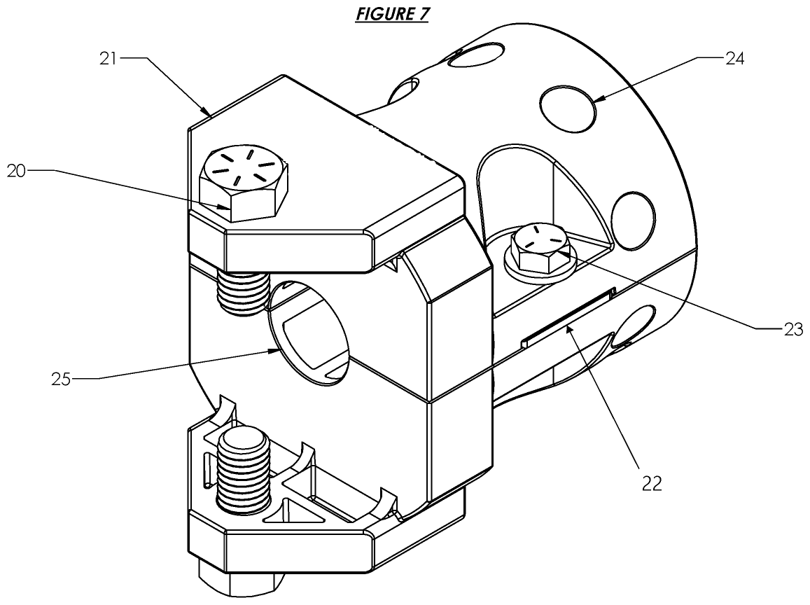

FIG. 8: Side view of bolted clamp halves attached to a torsion spring. This view shows the Torque Tool in its working position sandwiching a torsion rod (26) and secured to a torsion spring (28) via two of the existing four winding holes (27). The torsion spring cone set screws (not shown) have been removed from the threaded holes (29) for clarity.

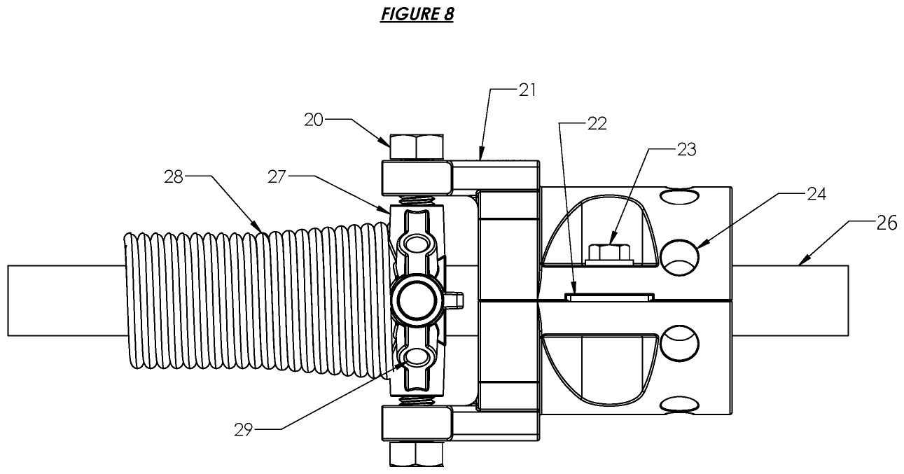

### DETAILED DESCRIPTION OF THE INVENTION

The Torque Tool is a simple two piece bolt-on-device, comprised of two identical halves, that attach to the end of a torsion spring and adds four more winding holes, for a total of eight holes, each spaced 45 degrees from one another, thus permitting 45 degrees of turn.

Realizing the need for versatility and ease of access in terms of attachment to existing 4 hole torsion spring winding cones, as well as ease of assembly of the two halves of the tool, the Torque Tool was originally designed with all of its current features without influence by any subsequently introduced designs or products that appeared in the public domain immediately prior to this submission. It is obvious that having removeable jaw pins and having more room for one's fingers to assemble the two halves of the tool, without the need for special bolts or tools, are unique advantages. These features give the Torque Tool the unique advantage of being able to be attached to an existing torsion spring winding cone in more than one way, making it more versatile and easier to use. Normally, with adequate clearance between the torsion spring winding cone and any adjacent obstructions, it can be assembled with both of the jaw bolts, or pins, in place in the jaw clamps. If adjacent obstructions do not permit enough room to sandwich the Torque Tool around the existing torsion spring cone with the jaw bolts, or pins, in place, then they can be removed and re-inserted once the Torque Tool is assembled and in place over the existing torsion spring winding cone.

Another way to install the Torque Tool is to remove both jaw bolts, or pins, and assemble both halves of the Torque Tool onto the torsion rod a distance away from the existing torsion spring winding cone then slide it into proper alignment over the existing torsion spring winding cone and then install one or both of the jaw bolts, or pins, into place. The Torque Tool can be operated with only one jaw bolt, or pin, in place if desired.

Since both halves of the Torque Tool are identical, the threaded assembly hole on each half is on the opposite side as the other when assembling. This provides an assembly advantage in cases where adjacent obstructions do not permit assembly as in the case if both threaded holes were on the same side as the obstructing surface. These methods of engagement with the existing torsion spring winding cone are desirable whenever one of the opposing winding holes is so obstructed that there is no room to insert the second half of the Torque Tool if it had a stationary jaw bolt, or pin, attached to the jaw. This provides several unique and advantageous alternate means of attaching the Torque Tool to torsion springs.

I claim the following:

1. A torsion spring adjustment tool for the purpose of winding, unwinding, loading or unloading torsion springs and comprised of:
1. Two each identical halves to be bolted together and manufactured from aluminum, steel or other suitable material using traditional casting and machining methods having an engagement jaw (21) bored at its end through its thickness and each half to include a removable jaw pin or hex head machine bolt (20) of adequate length to act as a winding peg.
2. Said halves to have adequate clearance above and around the assembly hole locations to permit the insertion of assembly bolts (23) using one's fingers without requiring special tools and comprised of one each non-threaded assembly bolt hole of adequate diameter along one edge and one each threaded hole of adequate diameter along the opposite edge.
3. Each said half shall have 4 winding holes (24) bored to adequate depth and diameter that are spaced 45 degrees apart so that when two halves are enjoined they create a total of 8 winding holes around the circumference of the assembled tool.
